(19) United States
(12) Patent Application Publication
(10) Pub. No.: US 2026/0333148 A1
(43) Pub. Date: Oct. 22, 2026

(54) METHOD FOR CONFIGURING MULTI-TIME ADVANCE GROUP (TAG) AND TIME ALIGNMENT TIMER (TAT), AND COMMUNICATION DEVICE

(71) Applicant: Beijing Xiaomi Mobile Software Co., Ltd., Beijing (CN)

(72) Inventor: Zhenyu ZHANG, Beijing (CN)

(73) Assignee: Beijing Xiaomi Mobile Software Co., Ltd., Beijing (CN)

(21) Appl. No.: 19/116,907

(22) PCT Filed: Sep. 30, 2022
(86) PCT No.: PCT/CN2022/123649

§ 371 Date: Mar. 28, 2025

(51) Int. Cl. H04W 36/00; H04L 5/00; H04W 74/0833

(52) U.S. Cl. CPC H04W 36/0072; H04L 5/0044; H04W 74/0833

(57) ABSTRACT

A method for configuring a multi-time advance group (TAG) and a time alignment timer (TAT), including: configuring at least one independent TAG for a transmission reception points (TRP), where a total number of the at least one independent TAG that is configurable does not exceed a predetermined threshold; and configuring one TAT for one TAG.

### CROSS-REFERENCE TO RELATED APPLICATION

The present application is a U.S. National Stage of International Application No. PCT/CN2022/123649, entitled “CONFIGURATION METHOD AND APPARATUS FOR MULTI-TIME ADVANCE GROUP (TAG) AND TIME ALIGNMENT TIMER (TAT)”, filed on Sep. 30, 2022, the contents of all of which are incorporated herein by reference in their entireties for all purposes.

### BACKGROUND OF THE INVENTION

In the related art, a group of serving cells are associated with the same time advance group (TAG) in an existing protocol, and all transmission reception points (TRPs) in the group of serving cells adopt the same timing advance (TA). One time alignment timer (TAT) is configured for each TAG, to control an uplink synchronization time of a serving cell associated with the TAG.

### SUMMARY OF THE INVENTION

The present disclosure relates to the technical field of communications, and in particular, to a method for configuring a multiple-time advance group (TAG) and a time alignment timer (TAT), and a communication device.

According to a first aspect of the embodiments of the present disclosure, a method for configuring a multiple-TAG and a TAT is provided. The method is performed by a network device and includes:
configuring at least one independent TAG for a transmission reception point (TRP), where a total number of the at least one independent TAG that is configurable does not exceed a predetermined threshold; and
configuring one TAT for one TAG.

According to a second aspect of the embodiments of the present disclosure, a communication device is further provided. The device includes one or more processor and a memory. The memory stores a computer program, and the one or more processors are communicatively coupled to the memory, wherein the computer program when collectively executed by the one or more processors causes the communication device to:
configure at least one independent TAG for a transmission reception point (TRP), wherein a total number of the at least one independent TAG that is configurable does not exceed a predetermined threshold; and
configure one TAT for one TAG.

According to a third aspect of the embodiments of the present disclosure, a non-transitory computer-readable storage medium storing instructions is provided. The instructions, when executed, implement the following steps:
configuring at least one independent TAG for a transmission reception point (TRP), wherein a total number of the at least one independent TAG that is configurable does not exceed a predetermined threshold; and
configuring one TAT for one TAG.

### BRIEF DESCRIPTION OF THE DRAWINGS

In order to illustrate the technical solutions in the embodiments of this application or the background more clearly, the accompanying drawings to be used in the embodiments of this application or the background will be introduced below.

FIG. 1 is a schematic diagram of an architecture of a communication system provided by an embodiment of the present disclosure;

FIG. 2 is a schematic flowchart of a method for configuring a multiple-- time advance group (TAG) and a time alignment timer (TAT) provided by an embodiment of the present disclosure;

FIG. 3 is a schematic flowchart of a method for configuring a multiple-TAG and a TAT provided by another embodiment of the present disclosure;

FIG. 4 is a schematic diagram of a TAC MAC-CE provided by an embodiment of the present disclosure;

FIG. 5 is a schematic flowchart of a method for configuring a multiple-TAG and a TAT provided by another embodiment of the present disclosure;

FIG. 6 is a schematic flowchart of a method for configuring a multiple-TAG and a TAT provided by another embodiment of the present disclosure;

FIG. 7 is a schematic flowchart of a method for configuring a multiple-TAG and a TAT provided by another embodiment of the present disclosure;

FIG. 8 is a schematic flowchart of a method for configuring a multiple-TAG and a TAT provided by another embodiment of the present disclosure;

FIG. 9 is a schematic diagram of a TAC MAC-CE provided by another embodiment of the present disclosure;

FIG. 10 is a schematic flowchart of a method for configuring a multiple-TAG and a TAT provided by another embodiment of the present disclosure;

FIG. 11 is a schematic flowchart of a method for configuring a multiple-TAG and a TAT provided by another embodiment of the present disclosure;

FIG. 12 is a schematic flowchart of a method for configuring a multiple-TAG and a TAT provided by another embodiment of the present disclosure;

FIG. 13 is a schematic flowchart of a method for configuring a multiple-TAG and a TAT provided by an embodiment of the present disclosure;

FIG. 14 is a schematic flowchart of a method for configuring a multiple-TAG and a TAT provided by another embodiment of the present disclosure;

FIG. 15 is a schematic flowchart of a method for configuring a multiple-TAG and a TAT provided by another embodiment of the present disclosure;

FIG. 16 is a schematic structural diagram of a network device provided by an embodiment of the present disclosure;

FIG. 17 is a schematic structural diagram of a communication device provided by an embodiment of the present disclosure; and

FIG. 18 is a schematic structural diagram of a chip provided by an embodiment of the present disclosure.

### DETAILED DESCRIPTION OF THE INVENTION

In order to better understand a method for configuring a multiple-time advance group (TAG) and a time alignment timer (TAT) disclosed in the embodiments of the present disclosure, a communication system to which the embodiments of the present disclosure are applicable is described below.

Referring to FIG. 1, FIG. 1 is a schematic diagram of an architecture of a communication system provided by an embodiment of the present disclosure. The communication system may include, but is not limited to, one network device and one terminal device. The number and form of the devices illustrated in FIG. 1 are for example and do not constitute a limitation to the embodiments of the present disclosure, and two or more network devices as well as two or more terminal devices may be included in actual applications. The communication system as shown in FIG. 1 includes one network device 11 and one terminal device 12, for example.

It needs to be noted that the technical solution in the embodiments of the present disclosure may be applicable to various communication systems, for example, a long term evolution (LTE) system, a 5th generation (5G) mobile communication system, a 5G new radio (NR) system, or other future new mobile communication systems, etc.

The network device 11 in the embodiments of the present disclosure is an entity at a network side for transmitting or receiving a signal. For example, the network device 101 may be an evolved NodeB (eNB), a transmission reception point (TRP), a next generation NodeB (gNB) in an NR system, a base station in other future mobile communication systems, or an access node in a wireless fidelity (WiFi) system, etc. The specific technology and specific device form adopted by the network device are not limited in the embodiments of the present disclosure. The network device provided by the embodiments of the present disclosure may consist of a central unit (CU) and a distributed unit (DU). The CU may also be referred to as a control unit, and the network device, such as a protocol layer of a base station, may be split by using a structure of the CU-DU. Functions of a part of the protocol layer are placed in the CU for centralized control, and functions of the remaining part or all of the protocol layer are distributed in the DU. The DU is centrally controlled by the CU.

The terminal device 12 in the embodiments of the present disclosure is an entity at a user side for receiving or transmitting a signal, for example, a mobile phone. The terminal device may be referred to as a terminal, a user equipment (UE), a mobile station (MS), a mobile terminal (MT), etc. The terminal device may be an automobile with a communication function, a smart automobile, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, etc. The specific technology and specific device form adopted by the terminal device are not limited in the embodiments of the present disclosure.

It may be understood that, the communication system described in the embodiments of the present disclosure are intended to explain technical solutions of the embodiments of the present disclosure more clearly, and does not constitute a limitation to the technical solutions provided in the embodiments of the present disclosure. Those of ordinary skill in the art may learn that, with the evolution of the system architecture and the emergence of new business scenarios, the technical solutions provided in the embodiments of the present disclosure are equally applicable to similar technical problems.

In the related art, a group of serving cells are associated with the same TAG in the existing protocol, and all transmission reception points (TRPs) in the group of serving cells adopt the same timing advance (TA). One TAT is configured for each TAG, to control uplink synchronization time of a serving cell associated with the TAG. When the terminal device receives a terminal device receives a time advance command (TAC) medium access control-control element (MAC-CE), the indicated TA will be used for a serving cell to which the TAG corresponds and start the TAT. After the TAT expires, a user equipment (UE) enters an out-of-step state. In this case, the terminal device cannot transmit an uplink channel or signal other than a physical random access channel (PRACH), and the terminal device initiates random access, acquires an initial TA, and restarts the TAT.

As a result, when a multiple input multiple output (MIMO) multiple-TRP (M-TRP) system supports two TAs, related enhancement on the TAG and the TAT is an urgent problem to be solved.

A method and device for configuring a multiple-time advance group (TAG) and a time alignment timer (TAT) provided in the present disclosure are introduced in detail in combination with the accompanying drawings.

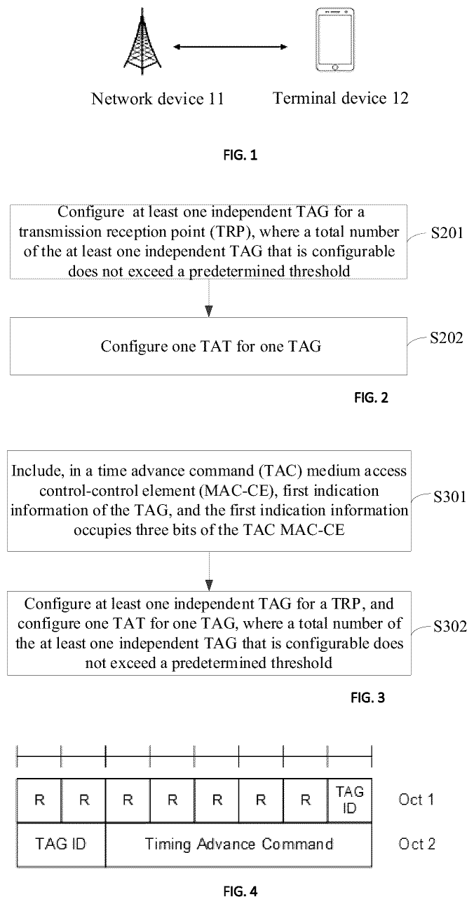

Referring to FIG. 2, FIG. 2 is a schematic flowchart of a method for configuring a multiple-TAG and a TAT provided by an embodiment of the present disclosure. The method is performed by the network device. As shown in FIG. 2, the method may include but is not limited to the following steps.

Step S201, configure at least one independent TAG for a transmission reception point (TRP), where a total number of the at least one independent TAG that is configurable does not exceed a predetermined threshold.

When configuring each intra-cell TRP or each TRP within a macro cell consisting of a plurality of inter-cells, the network device configures at least one independent TAG for each TRP.

The total number of the at least one independent TAG that is configurable in the network does not exceed the predetermined threshold. For example, the predetermined threshold is 8; for another example, the predetermined threshold is 16, which is not limited in the embodiments of the present disclosure.

Step S202, configure one TAT for one TAG.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

In summary, the network device configures at least one independent TAG for the TRP in the network, with the total number not exceeding the predetermined threshold, and at least one independent TAG is configured for one TRP, and each TAG is associated with one TAT. When the MIMO M-TRP system supports two TAs, related enhancement is performed on the TAG and the TAT, to control uplink and downlink synchronization time of the serving cell associated with the TAG.

The embodiments of the present disclosure neither limit a number of TRPs connected to the terminal device nor limit a number of TAs supported by the M-TRP system.

Referring to FIG. 3, FIG. 3 is a schematic flowchart of a method for configuring a multiple-time advance group (TAG) and a time alignment timer (TAT) provided by an embodiment of the present disclosure. The method is performed by the network device. As shown in FIG. 3, the method may include but not limited to the following steps.

As shown in FIG. 3, the method for configuring a multiple-time advance group (TAG) and a time alignment timer (TAT) may include the following steps.

Step S301, include, in a time advance command (TAC) medium access control-control element (MAC-CE), first indication information of the TAG, and the first indication information occupies three bits of the TAC MAC-CE.

In an embodiment of the present disclosure, the first indication information of the TAG is configured in the TAC MAC-CE, and the bits of the TAC MAC-CE occupied by the first indication information are associated with the predetermined threshold of the at least one independent TAG that is configurable in the network.

For example, the first indication information occupies three bits of the TAC MAC-CE. The total number of the at least one independent TAG that is configurable in the network is 23 i.e. 8.

For another example, the first indication information occupies four bits of the TAC MAC-CE. The total number of the at least one independent TAG that is configurable in the network is 2⁴ i.e. 16, which is not specifically limited in the embodiments of the present disclosure.

In order to facilitate understanding of the TAC MAC-CE, FIG. 4 is a schematic diagram of a TAC MAC-CE provided by an embodiment of the present disclosure. The first indication information of the TAG is a TAG ID as shown in FIG. 4. FIG. 4 is illustrated by taking the TAG ID occupying three bits of the TAC MAC-CE for example, which is not specifically limited.

Step S302, configure at least one independent TAG for a TRP, and configure one TAT for one TAG, where a total number of the at least one independent TAG that is configurable does not exceed a predetermined threshold.

When configuring each intra-cell TRP or each TRP within a macro cell consisting of a plurality of inter-cells, the network device configures at least one independent TAG for each TRP.

The total number of the at least one independent TAG that is configurable in the network does not exceed the predetermined threshold. For example, the predetermined threshold is 8; for another example, the predetermined threshold is 16, which is not limited in the embodiments of the present disclosure.

The terminal device may be connected to two TRPs for data communication, while each TRP in the network is associated with TAGs of no more than a predetermined threshold (for example, 8). One TAT is configured for each TAG to control an uplink synchronization time of a serving cell associated with the TAG.

In summary, the network device configures the first indication information of the TAG in the TAC MAC-CE. The first indication information occupies three bits of the TAC MAC-CE. The network device configures at least one independent TAG for the TRP, with the total number not exceeding the predetermined threshold (for example, 8), and one TAT is configured for one TRP, and each TAG is associated with one TAT. When the M-TRP system supports two or more TAs, related enhancement is performed on the TAG and the TAT, to control uplink and downlink synchronization time of the serving cell associated with the TAG.

Referring to FIG. 5, FIG. 5 is a schematic flowchart of a method for configuring a multiple-TAG and a TAT provided by an embodiment of the present disclosure. The method is performed by the network device. As shown in FIG. 5, the method may include but not limited to the following steps.

Step S501, set first two bits of an octet 2Oct2 and a last bit of an octet 1Oct1 in the TAC MAC-CE as first indication information of the TAG.

In an embodiment of the present disclosure, the first indication information of the TAG is configured in the TAC MAC-CE, and the bits of the TAC MAC-CE occupied by the first indication information are associated with the predetermined threshold of the at least one independent TAG that is configurable in the network.

Three bits of the TAC MAC-CE occupied by the first indication information is illustrated by continuing referring to setting the first two bits of the Oct2 and the last bit of the Oct1 in the TAC MAC-CE as the first indication information of the TAG in FIG. 4 for example.

For another example, the first indication information occupies four bits of the TAC MAC-CE. The total number of the at least one independent TAG that is configurable in the network is 2⁴ i.e. 16, which is not specifically limited in embodiments of the present disclosure.

In order to facilitate understanding of the TAC MAC-CE, FIG. 4 is a schematic diagram of a TAC MAC-CE provide by an embodiment of the present disclosure. The first indication information of the TAG is a TAG ID as shown in FIG. 4. FIG. 4 is illustrated by taking the TAG ID occupying three bits of the TAC MAC-CE for example, which is not specifically limited. The first two bits of the Oct2 and the last bit of the Oct1 in the TAC MAC-CE are set as the first indication information of the TAG. It needs to be noted that the Oct1 and the Oct2 shown in FIG. 4 are juxtaposed, or the Octl and the Oct2 are connected in series, which are not limited in the embodiments of the present disclosure.

Step S502, configure at least one independent TAG for a TRP, and configure one TAT for one TAG, where a total number of the at least one independent TAG that is configurable does not exceed a predetermined threshold.

When configuring each intra-cell TRP or each TRP within a macro cell consisting of a plurality of inter-cells, the network device configures at least one independent TAG for each TRP.

The total number of the at least one independent TAG that is configurable in the network does not exceed the predetermined threshold. For example, the predetermined threshold is 8; for another example, the predetermined threshold is 16, which is not limited in the embodiments of the present disclosure.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

In summary, the network device sets the first two bits of the Oct2 and the last bit of the Oct1 in the TAC MAC-CE as the first indication information of the TAG. The first indication information occupies three bits of the TAC MAC-CE. The network device configures at least one independent TAG for the TRP in the network, with the total number not exceeding 8, and at least one independent TAG is configured for one TRP, and each TAG is associated with one TAT. When the M-TRP system supports two or more TAS, related enhancement is performed on the TAG and the TAT, to control uplink and downlink synchronization time of the serving cell associated with the TAG.

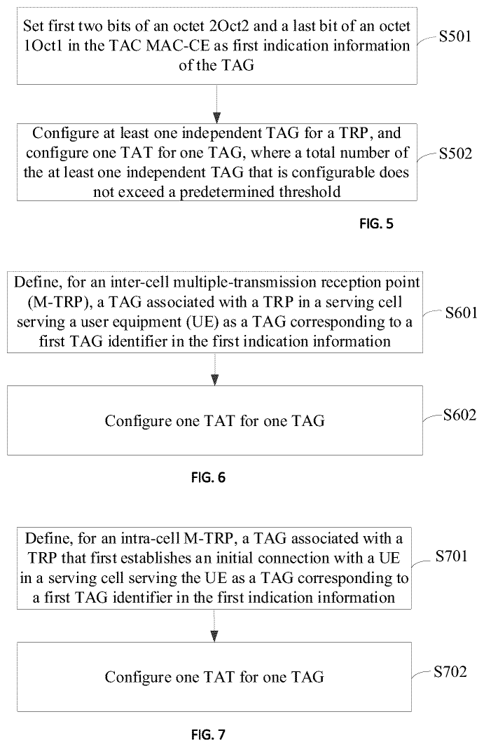

Referring to FIG. 6, FIG. 6 is a schematic flowchart of a method for configuring a multiple-TAG and a TAT provided by an embodiment of the present disclosure. The method is performed by the network device.

As shown in FIG. 6, the method for configuring a multiple-TAG and a TAT may include the following steps.

Step S601, define, for an inter-cell multiple-transmission reception point (M-TRP), a TAG associated with a TRP in a serving cell serving a user equipment (UE) as a TAG corresponding to a first TAG identifier in the first indication information.

The network device configures at least one independent TAG for the TRP, with the total number of no more than the predetermined threshold. One of the TAG may be defined as follows: in response to the M-TRP between different inter-cells, the TAG associated with the TRP in the serving cell serving the UE is defined as a TAG corresponding to the first TAG identifier in the first indication information in the inter-cell M-TRP.

The above process is a process of defining one TAG associated with a TRP in the serving cell serving the UE. Similarly, when a plurality of TAGs associated with the TRPs need to be defined, the process is the same as that of defining one TAG associated with a TRP in the serving cell serving the UE, which will not be specifically repeated.

For example, the inter-cell M-TRP may include but is not limited to inter-cells between different macro cells or inter-cells between cells, which is not specifically limited in the embodiments of the present disclosure.

The total number of the at least one independent TAG that is configurable in the network may be illustrated referring to the above embodiments, which will not be repeated here.

Step S602, configure one TAT for one TAG.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

In summary, the network device defines a TAG associated with a TRP that first establishes an initial connection with the UE in the serving cell serving the UE as a TAG corresponding to the first TAG identifier in the first indication information in response to the intra-cell M-TRP, and at least one independent TAG is configured for one TRP, and each TAG is associated with one TAT. When the MIMO M-TRP system supports two TAs, related enhancement is performed on the TAG and the TAT, to control uplink and downlink synchronization time of the serving cell associated with the TAG.

The method as illustrated in FIG. 6 is applicable to the configuration that the first indication information of the TAG is configured in the TAC MAC-CE and the first indication information occupies three bits of the TAC MAC-CE, and is also applicable to the configuration that the second indication information of the TAG is configured in the TAC MAC-CE and the second indication information occupies four bits of the TAC MAC-CE. The implementation when the network device defines a TAG associated with a TRP in the serving cell serving the UE as a TAG corresponding to the first TAG identifier in the second indication information in response to the inter-cell M-TRP may refer to the step S601. Both are the same in implementation and differ in that the first indication information occupies three bits of the TAC MAC-CE, and the second indication information occupies four bits of the TAC MAC-CE, which will not be repeated in the embodiments of the present disclosure.

Referring to FIG. 7, FIG. 7 is a schematic flowchart of a method for configuring a multiple-TAG and a TAT provided by an embodiment of the present disclosure. The method is performed by the network device.

As shown in FIG. 7, the method for configuring a multiple-TAG and a TAT may include the following steps.

Step S701, define, for an intra-cell M-TRP, a TAG associated with a TRP that first establishes an initial connection with a UE in a serving cell serving the UE as a TAG corresponding to a first TAG identifier in the first indication information.

The network device configures at least one independent TAG for the TRP, with the total number of no more than the predetermined threshold. One of the TAG may be defined as follows: in response to the intra-cell M-TRP, the TAG associated with the TRP that first establishes an initial connection with the UE in the serving cell serving the UE is defined as a TAG corresponding to the first TAG identifier in the first indication information.

For example, the intra-cell M-TRP may include but is not limited to inter-cells within different macro cells or inter-cells within cells, which is not specifically limited in the embodiments of the present disclosure.

The total number of the at least one independent TAG that is configurable in the network may be illustrated referring to the above embodiments, which will not be repeated here.

Step S702, configure one TAT for one TAG.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

The method as illustrated in FIG. 7 is applicable to the configuration that the first indication information of the TAG is configured in the TAC MAC-CE and the first indication information occupies three bits of the TAC MAC-CE, and is also applicable to the configuration that the second indication information of the TAG is configured in the TAC MAC-CE and the second indication information occupies four bits of the TAC MAC-CE. The implementation when the network device defines a TAG associated with a TRP that first establishes an initial connection with the UE in the serving cell serving the UE as a TAG corresponding to the first TAG identifier in the second indication information in response to the intra-cell M-TRP may refer to step S701. Both are the same in implementation and differ in that the first indication information occupies three bits of the TAC MAC-CE, and the second indication information occupies four bits of the TAC MAC-CE, which will not be repeated in the embodiments of the present disclosure.

In summary, the network device defines a TAG associated with a TRP that first establishes an initial connection with the UE in the serving cell serving the UE as a TAG corresponding to the first TAG identifier in the first indication information in response to the intra-cell M-TRP, and at least one independent TAG is configured for one TRP, and each TAG is associated with one TAT. When the MIMO M-TRP system supports two TAs, related enhancement is performed on the TAG and the TAT, to control uplink and downlink synchronization time of the serving cell associated with the TAG.

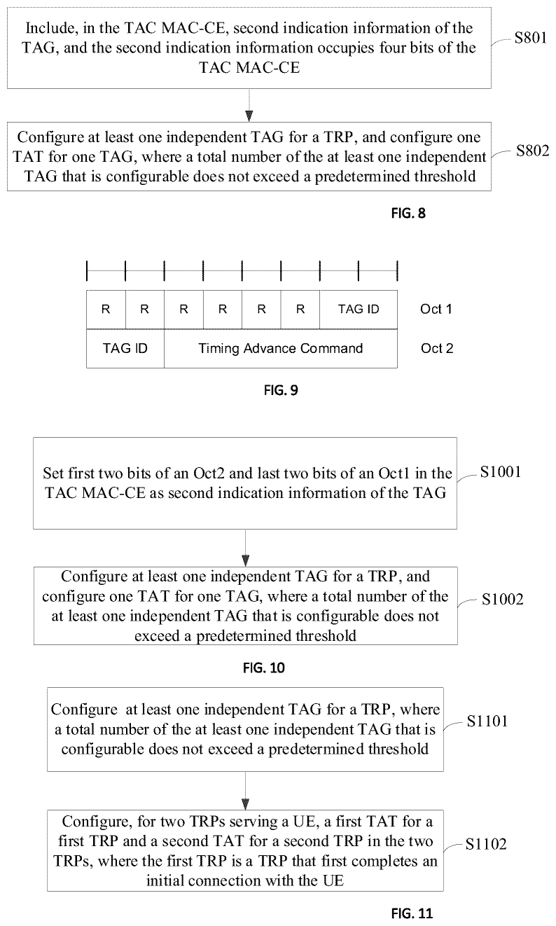

Referring to FIG. 8, FIG. 8 is a schematic flowchart of a method for configuring a multiple-TAG and a TAT provided by an embodiment of the present disclosure. The method is performed by the network device.

As shown in FIG. 8, the method for configuring a multiple-TAG and a TAT may include the following steps.

Step S801, include, in the TAC MAC-CE, second indication information of the TAG, and the second indication information occupies four bits of the TAC MAC-CE.

In an embodiment of the present disclosure, the second indication information of the TAG is configured in the TAC MAC-CE, and the bits of the TAC MAC-CE occupied by the second indication information are associated with the predetermined threshold of the at least one independent TAG that is configurable in the network.

In order to facilitate understanding of the TAC MAC-CE, FIG. 9 is a schematic diagram of a TAC MAC-CE provided by an embodiment of the present disclosure. The first indication information of the TAG is a TAG ID as shown in FIG. 9. FIG. 9 is illustrated by taking the TAG ID occupying four bits of the TAC MAC-CE for example, which is not specifically limited.

For example, the second indication information occupies four bits of the TAC MAC-CE. The predetermined threshold of the at least one independent TAG that is configurable in the network is 2⁴ i.e. 16. Specifically, the predetermined threshold is not limited in the embodiments of the present disclosure.

Illustration of the TAC MAC-CE may refer to FIG. 4 and related embodiments, which will not be repeated here one by one.

Step S802, configure at least one independent TAG for a TRP, and configure one TAT for one TAG, where a total number of the at least one independent TAG that is configurable does not exceed a predetermined threshold.

When configuring each intra-cell TRP or each TRP within a macro cell consisting of a plurality of inter-cells, the network device configures at least one independent TAG for each TRP.

The total number of the at least one independent TAG that is configurable in the network does not exceed the predetermined threshold. For example, the predetermined threshold is 8; for another example, the predetermined threshold is 16, which is not limited in the embodiments of the present disclosure.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

In summary, the network device configures the second indication information of the TAG in the TAC MAC-CE. The second indication information occupies four bits of the TAC MAC-CE. The network device configures at least one independent TAG for the TRP in the network, with the total number not exceeding 16, and each TAG is associated with one TAT. When the M-TRP system supports two or more TAs, related enhancement is performed on the TAG and the TAT, to control uplink and downlink synchronization time of the serving cell associated with the TAG.

Referring to FIG. 10, FIG. 10 is a schematic flowchart of a method for configuring a multiple-TAG and a TAT provided by an embodiment of the present disclosure. The method is performed by the network device. The method includes the following steps.

Step S1001, set first two bits of an Oct2 and last two bits of an Oct1 in the TAC MAC-CE as second indication information of the TAG.

In an embodiment of the present disclosure, the second indication information of the TAG is configured in the TAC MAC-CE, and the bits of the TAC MAC-CE occupied by the second indication information are associated with the predetermined threshold of the at least one independent TAG that is configurable in the network.

Four bits of the TAC MAC-CE occupied by the second indication information is illustrated by continuing referring to setting the first two bits of the Oct2 and the last two bits of the Oct1 in the TAC MAC-CE as the first indication information of the TAG in FIG. 9 for example. The illustration of Oct1 and Oct2 may refer to FIG. 4 and related descriptions, and will not be repeated here.

Step S1002, configure at least one independent TAG for a TRP, and configure one TAT for one TAG, where a total number of the at least one independent TAG that is configurable does not exceed a predetermined threshold.

When configuring each intra-cell TRP or each TRP within a macro cell consisting of a plurality of inter-cells, the network device configures at least one independent TAG for each TRP.

The total number of the at least one independent TAG that is configurable in the network does not exceed the predetermined threshold. For example, the predetermined threshold is 8; for another example, the predetermined threshold is 16, which is not limited in the embodiments of the present disclosure.

The terminal device may be connected to two TRPs for data communication, while each TRP in the network is associated with TAGs of no more than the predetermined threshold (for example, 8). One TAT is configured for each TAG to control an uplink synchronization time of a serving cell associated with the TAG.

In summary, the network device sets the first two bits of the Oct2 and the last bit of the Oct1 in the TAC MAC-CE as the first indication information of the TAG. The first indication information occupies three bits of the TAC MAC-CE. The network device configures at least one independent TAG for the TRP in the network, with the total number not exceeding the predetermined threshold, and each TAG is associated with one TAT. When the M-TRP system supports two or more TAs, related enhancement is performed on the TAG and the TAT, to control uplink and downlink synchronization time of the serving cell associated with the TAG.

Referring to FIG. 11, FIG. 11 is a schematic flowchart of a method for configuring a multiple-TAG and a TAT provided by an embodiment of the present disclosure. The method is performed by the network device and includes the following steps.

Step S1101, configure at least one independent TAG for a TRP, where a total number of the at least one independent TAG that is configurable does not exceed a predetermined threshold.

Related descriptions of configuring at least one independent TAG for each TRP may refer to detailed descriptions of the above embodiments, which will not be repeated here.

Step S1102, configure, for two TRPs serving a UE, a first TAT for a first TRP and a second TAT for a second TRP in the two TRPs, where the first TRP is a TRP that first completes an initial connection with the UE.

One independent TAG may be configured for one TRP, and one TAG corresponds to one TAT.

After completing the TAT configuration, the network device configures, in response to the two TRPs serving the UE, the first TAT for the first TRP in the two TRPs. The first TRP is a TRP that first completes the initial connection with the UE.

The network device configures the second TAT for the second TRP.

In summary, the network device completes the configuration of at least one independent TAG for each TRP, the total number of the at least one independent TAG that is configurable in the network not exceeding the predetermined threshold; and configures, in response to two TRPs serving the UE, the first TAT for the first TRP and the second TAT for the second TRP in the two TRPs, where the first TRP is a TRP that first completes the initial connection with the UE. The first TRP is associated with the first TAT, and the second TRP is associated with the second TAT. When the M-TRP system supports two or more TAs, related enhancement is performed on the TAG and the TAT, to control uplink and downlink synchronization time of the serving cell associated with the TAG.

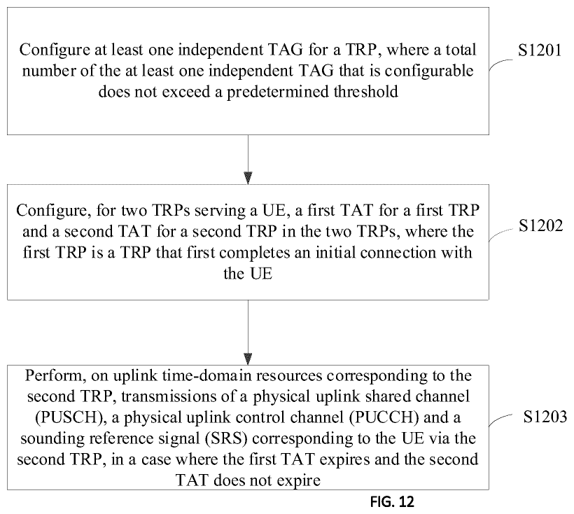

Referring to FIG. 12, FIG. 12 is a schematic flowchart of a method for configuring a multiple-TAG and a TAT provided by an embodiment of the present disclosure. The method is performed by the network device and includes the following steps.

Step S1201, configure at least one independent TAG for a TRP, where a total number of the at least one independent TAG that is configurable does not exceed a predetermined threshold.

Related descriptions of configuring at least one independent TAG for each TRP may refer to detailed descriptions of the above embodiments, which will not be repeated here.

Step S1202, configure, for two TRPs serving a UE, a first TAT for a first TRP and a second TAT for a second TRP in the two TRPs, where the first TRP is a TRP that first completes an initial connection with the UE.

One independent TAG may be configured for one TRP, and one TAG corresponds to one TAT.

After completing the TAT configuration, the network device configures, in response to the two TRPs serving the UE, the first TAT for the first TRP in the two TRPs. The first TRP is a TRP that first completes the initial connection with the UE.

The network device configures the second TAT for the second TRP.

Step S1203, perform, on uplink time-domain resources corresponding to the second TRP, transmissions of a physical uplink shared channel (PUSCH), a physical uplink control channel (PUCCH) and a sounding reference signal (SRS) corresponding to the UE via the second TRP, in a case where the first TAT expires and the second TAT does not expire.

At least one independent TAG is configured for each TRP, and one TAT is configured for one TAG. Assuming that the first TRP first completes the initial connection with the UE and the first TAT of the first TRP first expires, after the first TAT of the first TRP expires, the first TRP cannot perform transmissions of the PUSCH, the PUCCH and the sounding reference signal (SRS).

The second TRP corresponds to the uplink time-domain resources, the second TRP maintains the existing TA, perform transmissions of the PUSCH, the PUCCH and the SRS corresponding to the UE.

In summary, the network device completes the configuration of at least one independent TAG for each TRP, the total number of the at least one independent TAG that is configurable in the network not exceeding the predetermined threshold; and configures, in response to the two TRPs serving the UE, the first TAT for the first TRP and the second TAT for the second TRP in the two TRPs. In a case where the first TAT expires and the second TRP does not expire, transmissions of the PUSCH, the PUCCH and the SRS corresponding to the UE are performed on the uplink time-domain resources corresponding to the second TRP via the second TRP. When the M-TRP system supports two or more TAs, related enhancement is performed on the TAG and the TAT, to control uplink and downlink synchronization time of the serving cell associated with the TAG.

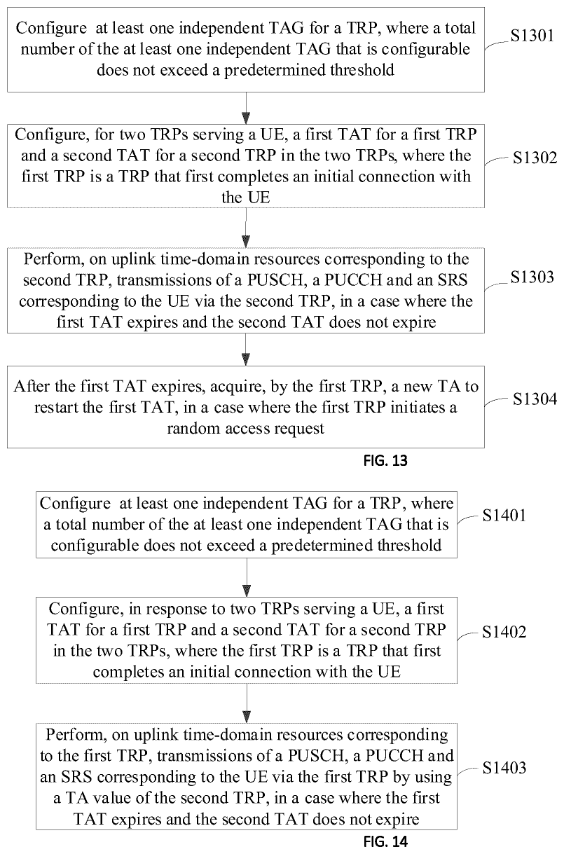

Referring to FIG. 13, FIG. 13 is a schematic flowchart of a method for configuring a multiple-TAG and a TAT provided by an embodiment of the present disclosure. The method is performed by the network device and includes the following steps.

Step S1301, configure at least one independent TAG for a TRP, where a total number of the at least one independent TAG that is configurable does not exceed a predetermined threshold.

Step S1302, configure, for two TRPs serving a UE, a first TAT for a first TRP and a second TAT for a second TRP in the two TRPs, where the first TRP is a TRP that first completes an initial connection with the UE.

Steps S1301 and S1302 may refer to detailed descriptions of the above embodiments, which will not be repeated here.

Step S1303, perform, on uplink time-domain resources corresponding to the second TRP, transmissions of a PUSCH, a PUCCH and an SRS corresponding to the UE via the second TRP, in a case where the first TAT expires and the second TAT does not expire.

At least one independent TAG is configured for each TRP, and one TAT is configured for one TAG. Assuming that the first TRP first completes the initial connection with the UE and the first TAT of the first TRP first expires, after the first TAT of the first TRP expires, the first TRP cannot perform transmissions of the PUSCH, the PUCCH and the SRS.

The second TRP corresponds to the uplink time-domain resources, the second TRP maintains the existing TA, perform transmissions of the PUSCH, the PUCCH and the SRS corresponding to the UE.

Step S1304, after the first TAT expires, acquire, by the first TRP, a new TA to restart the first TAT, in a case where the first TRP initiates a random access request.

The first TRP initiates the random access request, acquires the new TA to restart the TAT, and maintains the TA until the TAT expires.

For example, the first TRP initiating the random access request includes: the UE autonomously initiating the random access request.

For another example, the random access request is initiated by triggering the first TRP via a physical downlink control channel (PDCCH) command. The manner in which the first TRP initiates the random access request is not limited in the embodiments of the present disclosure.

In summary, the network device completes the configuration of at least one independent TAG for each TRP, the total number of the at least one independent TAG that is configurable in the network not exceeding the predetermined threshold; and configures, in response to the two TRPs serving the UE, the first TAT for the first TRP and the second TAT for the second TRP in the two TRPs. In a case where the first TAT expires and the second TRP does not expire, transmissions of the PUSCH, the PUCCH and the SRS corresponding to the UE are performed on the uplink time-domain resources corresponding to the second TRP via the second TRP. After the first TAT expires, in response to the random access request initiated by the first TRP, the first TRP acquires the new TA to restart the first TAT. When the M-TRP system supports two or more TAs, related enhancement is performed on the TAG and the TAT, to control uplink and downlink synchronization time of the serving cell associated with the TAG.

Referring to FIG. 14, FIG. 14 is a schematic flowchart of a method for configuring a multiple-TAG and a TAT provided by an embodiment of the present disclosure. The method is performed by the network device and includes the following steps.

Step S1401, configure at least one independent TAG for a TRP, where a total number of the at least one independent TAG that is configurable does not exceed a predetermined threshold.

Step S1402, configure, in response to two TRPs serving a UE, a first TAT for a first TRP and a second TAT for a second TRP in the two TRPs, where the first TRP is a TRP that first completes an initial connection with the UE.

Steps S1401 and S1402 may refer to detailed descriptions of the above embodiments, which will not be repeated here.

Step S1403, perform, on uplink time-domain resources corresponding to the first TRP, transmissions of a PUSCH, a PUCCH and an SRS corresponding to the UE via the first TRP by using a TA value of the second TRP, in a case where the first TAT expires and the second TAT does not expire.

The first TAT expires, that is, the first TRP cannot perform the transmission of the PUSCH/PUCCH/SRS, and the second TAT does not expire, in which case, the first TRP is configured to perform, on uplink time-domain resources corresponding to the first TRP, transmissions of the PUSCH, the PUCCH and the SRS corresponding to the UE via the first TRP by using the TA value of the second TRP, until the TAT of the second TRP expires.

In summary, the network device completes the configuration of at least one independent TAG for each TRP, the total number of the at least one independent TAG that is configurable in the network not exceeding the predetermined threshold; and configures, in response to the two TRPs serving the UE, the first TAT for the first TRP and the second TAT for the second TRP in the two TRPs. In a case where the first TAT expires and the second TRP does not expire, transmissions of the PUSCH, the PUCCH and the SRS corresponding to the UE are performed on the uplink time-domain resources corresponding to the first TRP via the first TRP by using the TA value of the second TRP. When the M-TRP system supports two or more TAs, related enhancement is performed on the TAG and the TAT, to control uplink and downlink synchronization time of the serving cell associated with the TAG.

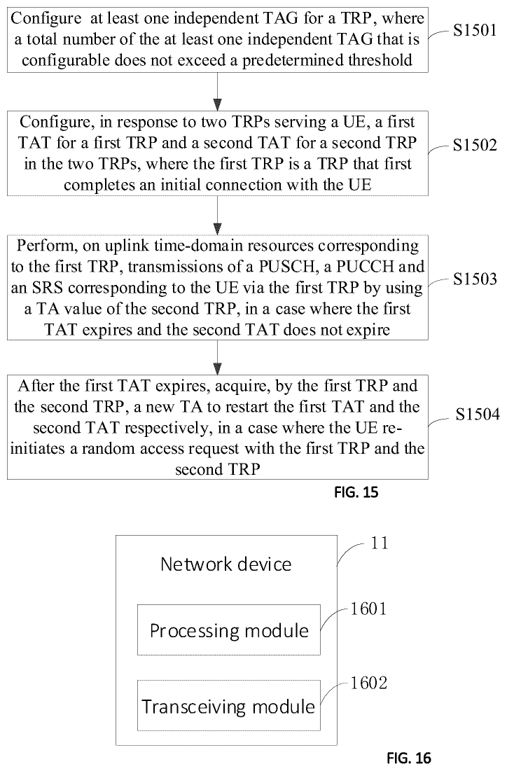

Referring to FIG. 15, FIG. 15 is a schematic flowchart of a method for configuring a multiple-TAG and a TAT provided by an embodiment of the present disclosure. The method is performed by the network device and includes the following steps.

Step S1501, configure at least one independent TAG for a TRP, where a total number of the at least one independent TAG that is configurable does not exceed a predetermined threshold.

Step S1502, configure, in response to two TRPs serving a UE, a first TAT for a first TRP and a second TAT for a second TRP in the two TRPs, where the first TRP is a TRP that first completes an initial connection with the UE.

Step S1503, perform, on uplink time-domain resources corresponding to the first TRP, transmissions of a PUSCH, a PUCCH and an SRS corresponding to the UE via the first TRP by using a TA value of the second TRP, in a case where the first TAT expires and the second TAT does not expire.

Steps S1501 to S1503 may refer to detailed descriptions of the above embodiments, which will not be repeated here.

Step S1504, after the first TAT expires, acquire, by the first TRP and the second TRP, a new TA to restart the first TAT and the second TAT respectively, in a case where the UE re-initiates a random access request with the first TRP and the second TRP.

After the first TAT expires, the UE re-initiates the random access request with the first TRP and the second TRP, acquires the new TA to restart the TAT, and maintains the TA until the TAT expires.

Corresponding to the method for configuring a multiple-TAG and a TAT provided by the embodiments of FIG. 2 to FIG. 15, the present disclosure further provides a network device. Since the network device provided by the embodiments of the present disclosure corresponds to the method for configuring a multiple-TAG and a TAT provided by the embodiments of FIG. 2 to FIG. 15, the implementation of the method for configuring a multiple-TAG and a TAT are also applicable to the network device provided by the embodiments of the present disclosure, which will not be described in detail in the embodiments of the present disclosure.

FIG. 16 shows a network device provided by an embodiment of the present disclosure. The network device 11 includes:
a processing module 1601, configured to configure at least one independent TAG for a transmission reception point (TRP), where a total number of the at least one independent TAG that is configurable does not exceed a predetermined threshold; and
configure one TAT for one TAG.

In an implementation, a time advance command (TAC) medium access control-control element (MAC-CE) includes first indication information of the TAG, and the first indication information occupies three bits of the TAC MAC-CE; and the predetermined threshold is 8.

In an implementation, the TAC MAC-CE including the first indication information of the TAG includes:
setting first two bits of an octet 2Oct2 and a last bit of an octet 1Oct1 in the TAC MAC-CE as the first indication information of the TAG.

In an implementation, the processing module 1601 is further configured to:
define, for an inter-cell multiple-transmission reception point (M-TRP), a TAG associated with a TRP in a serving cell serving a user equipment (UE) as a TAG corresponding to a first TAG identifier in the first indication information.

In an implementation, the processing module 1601 is further configured to:
define, for an intra-cell M-TRP, a TAG associated with a TRP that first establishes an initial connection with a UE in a serving cell serving the UE as a TAG corresponding to a first TAG identifier in the first indication information.

In an implementation, the TAC MAC-CE includes second indication information of the TAG, and the second indication information occupies four bits of the TAC MAC-CE; and the predetermined threshold is 16.

In an implementation, the TAC MAC-CE including the second indication information of the TAG includes:
setting first two bits of an Oct2 and last two bits of an Oct1 in the TAC MAC-CE as the second indication information of the TAG.

In an implementation, the processing module 1601 is further configured to:
define for an inter-cell M-TRP, a TAG associated with a TRP in a serving cell serving a UE as a TAG corresponding to a first TAG identifier in the second indication information.

In an implementation, the processing module 1601 is further configured to:
define, for an intra-cell M-TRP, a TAG associated with a TRP that first establishes an initial connection with a UE in a serving cell serving the UE as a TAG corresponding to a first TAG identifier in the second indication information.

In an implementation, the processing module 1601 is further configured to:
configure, for two TRPs serving a UE, a first TAT for a first TRP and a second TAT for a second TRP in the two TRPs, where the first TRP is a TRP that first completes an initial connection with the UE.

In an implementation, the network device 11 further includes:
a transceiving module 1602, configured to perform, on uplink time-domain resources corresponding to the second TRP, transmissions of a physical uplink shared channel (PUSCH), a physical uplink control channel (PUCCH) and a sounding reference signal (SRS) corresponding to the UE via the second TRP, in a case where the first TAT expires and the second TAT does not expire.

In an implementation, after the first TAT expires, the transceiving module 1602 is further configured to, acquire, by the first TRP, a new TA to restart the first TAT, in a case where the first TRP initiates a random access request.

In an implementation, the first TRP initiating the random access request includes:
triggering, via a physical downlink control channel (PDCCH) command, the random access request initiated by the first TRP.

In an implementation, the transceiving module 1602 is further configured to:
Perform, on uplink time-domain resources corresponding to the first TRP, transmissions of a PUSCH, a PUCCH and an SRS corresponding to the UE via the first TRP by using a TA value of the second TRP, in a case where the first TAT expires and the second TAT does not expire.

In an implementation, after the first TAT expires, the processing module 1601 is further configured to:
acquire, by the first TRP and the second TRP, a new TA to restart the first TAT and the second TAT respectively, in a case where the UE re-initiates a random access request with the first TRP and the second TRP.

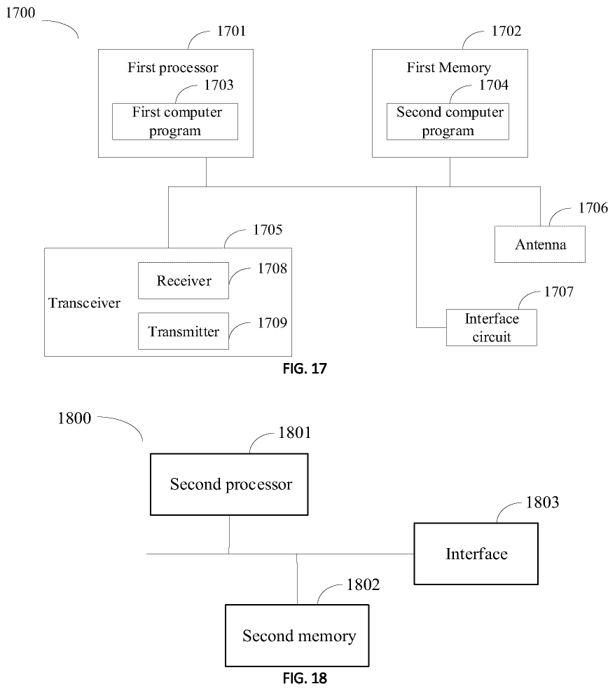

Referring to FIG. 17, FIG. 17 is a schematic structural diagram of a communication device according to another embodiment of the present disclosure. In FIG. 17, the communication device 1700 may be a network device, a relay terminal device, a chip, a system on chip, or a processor, etc. that supports the network device to implement the above method, or a chip, a system on chip, or a processor, etc. that supports the terminal device to implement the above method. The device may be configured to implement the method described in the above method embodiments, and may specifically refer to descriptions in the above method embodiments.

The communication device 1700 may include one or more first processors 1701. The first processor 1701 may be a general purpose processor or a dedicated processor, etc. For example, the first processor 1701 may be a baseband processor or a central processor. The baseband processor may be configured to process a communication protocol and communication data, and the central processor may be configured to control a communication device (e.g., a base station, a baseband chip, a terminal device, a terminal device chip, a DU or CU, etc.), to execute a computer program, and process data of the computer program.

In some examples, the communication device 1700 may further include one or more first memories 1702 storing a second computer program 1704. The first processor 1701 executes the second computer program 1704 so that the communication device 1700 performs the method as described in the above method embodiments. In some examples, the first memory 1702 may further store data. The communication device 1700 and the first memory 1702 may be independently configured or integrated together.

In some examples, the communication device 1700 may further include a transceiver 1705 and an antenna 1706. The transceiver 1705 may be referred to as a transceiving unit, a transceiving device, or a transceiving circuit, etc., for implementing a transceving function. The transceiver 1705 may include a receiver 1708 and a transmitter 1709. The receiver 1708 may be referred to as a receiving device or a receiving circuit, etc., for implementing a receiving function; the transmitter 1709 may be referred to as a transmission device or a transmission circuit, etc. for implementing a transmitting function.

In some examples, the communication device 1700 may further include one or more interface circuits 1707 configured to receive code instructions and transmit the code instructions to the first processor 1701. The first processor 1701 runs the code instructions so that the communication device 1700 performs the method described in the above method embodiments.

The communication device 1700 is the relay terminal device: the first processor 1701 is configured to execute the step S202 in FIG. 2, the step S302 in FIG. 3, the step S402 in FIG. 4, the step S503 in FIG. 5, etc.

The communication device 1700 is the network device: the transceiver 1705 is configured to execute the step S1202 in FIG. 12, etc.

In an implementation, the first processor 1701 may include a transceiver configured to implement receiving and transmitting functions. For example, the transceiver may be a transceiving circuit, or an interface, or an interface circuit. The transceiving circuit, the interface or the interface circuit configured to implement receiving and transmitting functions may be separate or integrated together. The above transceiving circuit, interface or interface circuit may be configured to read and write codes/data, or the above transceiving circuit, interface or interface circuit may be configured to transmit or deliver a signal.

In an implementation, the first processor 1701 may store a first computer program 1703. The first computer program 1703 runs on the first processor 1701 so that the communication device 1700 performs the method as described in the above method embodiments. The first computer program 1703 may be solidified in the first processor 1701, in which case the first processor 1701 may be implemented by hardware.

In an implementation, the communication device 1700 may include a circuit that may implement a transmitting or receiving or communication function in the above method embodiments. The processor and the transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may also be fabricated by using various IC process technologies, such as complementary metal oxide semiconductor (CMOS), nMetal-oxide-semiconductor (NMOS), positive channel metal oxide semiconductor (PMOS), bipolar junction transistor(BJT), bipolar CMOS (BiCMOS), silicon germanium (SiGe), and gallium arsenide (GaAs).

The communication device described in the above embodiments may be the network device, or the terminal device, but the scope of the communication device described in the present disclosure is not limited thereto, and a structure of the communication device may not be subject to FIG. 17. The communication device may be a stand-alone device or may be a part of a larger device. For example, the communication device may be:
(1) a stand-alone integrated circuit (IC), or a chip, or a system on chip or a subsystem;
(2) a set of one or more ICs, in some examples, the set of IC may also include a storage component for storing data and a computer program;
(3) an ASIC, such as a Modem;
(4) a module that may be embedded within other devices;
(5) a receiver, a terminal device, a smart terminal device, a cellular phone, a wireless device, a handset, a mobile unit, a vehicle device, a network device, a cloud device, an artificial intelligence device, etc.; and
(6) others, etc.

In a case where the communication device may be the chip or the system on chip, reference is made to the schematic structural diagram of a chip as shown in FIG. 18. The chip 1800 shown in FIG. 18 may include a second processor 1801 and an interface 1803. There may be one or more second processors 1801, and there may be a plurality of interfaces 1803.

In some examples, the chip 1800 further includes a second memory 1802 configured to save a necessary computer program and data.

Those skilled in the related art may also understand that various illustrative logical blocks and steps listed in the embodiments of the present disclosure may be implemented by electronic hardware, computer software, or a combination of both. Whether the function is implemented by hardware or software depends on specific applications and design requirements for an overall system. Those skilled in the art may implement the functions by using various methods for each specific application, but such an implementation may not be understood as beyond the protection scope of the embodiments of the present disclosure.

The present disclosure further provides a non-transitory readable storage medium with instructions stored thereon. The instructions, when executed by a computer, implement the function in any of the above method embodiments.

The present disclosure further provides a computer program product. The computer program product, when executed by a computer, implements the function in any of the above method embodiments.

The present disclosure further provides a system on chip (SoC) is provided. The SoC includes at least one processor and an interface, and is configured to support a communication device to perform functions in any of the above method embodiments, and for example, to determine or process at least one of data and information involved in the above methods. In a possible design, the SoC further includes a memory. The memory is configured to save a computer program and data necessary for the communication device. The SoC may consist of a chip, or may include a chip and other discrete devices.

The present disclosure further provides a computer program. When the computer program is running on a computer, the computer is caused to perform any of the above method.

As used herein, the term processor may refer to one processor that performs the defined functions or a plurality of processors that collectively perform defined functions, such that the execution of the individual defined functions may be divided amongst such processors.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to the embodiments of the present disclosure are wholly or partially generated when the computer program is loaded and executed on a computer. The computer may be a general purpose computer, a dedicated computer, a computer network, or other programmable device. The computer program may be stored in a non-transitory computer-readable storage medium or transmitted from one non-transitory computer-readable storage medium to another. For example, the computer program may be transmitted from one website, computer, server, or data center to another in a wire (such as a coaxial cable, a fiber optic, and a digital subscriber line (DSL)) or wireless (such as infrared, wireless, and microwave) manner. The non-transitory computer-readable storage medium may be any available medium that can be accessed by a computer, or a data storage device such as a server that integrates one or more of the available media, and a data center. The available medium may be a magnetic medium (such as a floppy disk, a hard disk, and a magnetic tape), an optical medium (such as a digital video disk (DVD)), or a semiconductor medium (such as a solid state disk (SSD)), etc.

Those of ordinary skill in the art may understand that various numbers such as first and second involved in the present disclosure are distinguished for convenience of description, and are not intended to limit the scope of the embodiments of the present disclosure or to indicate an order of precedence.

At least one in the present disclosure may also be described as one or more, and a plurality of may be two, three, four or more, which is not limited in the present disclosure. In the embodiments of the present disclosure, for a kind of technical feature, technical features in the kind of technical feature are distinguished by “first”, “second”, “third”, “A”, “B”, “C”, “D”, etc., and there is no order of precedence or magnitude between technical features described in “first”, “second”, “third”, “A”, “B”, “C” and “D”.

It may be further understood that, “a plurality of” in the present disclosure means two or more, which is similar to other quantifiers. “And/or” describes the relationship of association objects, indicating that there may exist three relationships. For example, A and/or B may represent: existing A alone, existing both A and B, or existing B alone. The character “/” generally means the contextual object is a kind of “or” relationship. The singular forms “a”, “an”, “the” and “said” are also intended to include plural forms, unless the context clearly indicates otherwise.

It may be understood that the meaning of the words such as “in response to”, “if” and “in a case of” involved in the present disclosure depends on the context and the actual use scenario. For example, the word “in a case of” used here may be interpreted as “in a case where” or “when”.

Corresponding relationships indicated by tables in the present disclosure may be configured or predefined. Values of information in tables are examples, and may be configured as other values, which are not limited in the present disclosure. When corresponding relationships between information and parameters are configured, all corresponding relationships indicated in tables do not need to be configured. For example, in the tables in the present disclosure, corresponding relationships indicated by some rows may not be configured. For another example, appropriate transformations and adjustments, such as splitting and merging, may be made based on the above tables. Names of parameters shown in headers in the tables may be other names understandable by the communication device, and values or representations of the parameters may be other values or representations understandable by the communication device. Each of the above tables may also be implemented with other data structures, for example, arrays, queues, containers, stacks, linear lists, pointers, linked lists, trees, graphs, structures, classes, heaps or hash tables, etc.

1. A method for configuring a multiple-time advance group (TAG) and a time alignment timer (TAT), performed by a network device, the method comprising:
configuring at least one independent TAG for a transmission reception point (TRP), wherein a total number of the at least one independent TAG that is configurable does not exceed a predetermined threshold; and
configuring one TAT for one TAG.

2. The method according to claim 1, wherein a time advance command (TAC) medium access control-control element (MAC-CE) comprises first indication information of a TAG, and the first indication information occupies three bits of the TAC MAC-CE; and wherein the predetermined threshold is 8.

3. The method according to claim 2, wherein the TAC MAC-CE comprising the first indication information of the TAG comprises: setting first two bits of an octet 2Oct2 and a last bit of an octet 1Oct1 in the TAC MAC-CE as the first indication information of the TAG.

4. The method according to claim wherein configuring the at least one independent TAG for the TRP comprises:
defining, for an inter-cell multiple-transmission reception point (M-TRP), a TAG associated with a TRP in a serving cell serving a user equipment (UE) as a TAG corresponding to a first TAG identifier in the first indication information.

5. The method according to claim 2, wherein configuring the at least one independent TAG for the TRP comprises:
defining, for an intra-cell M-TRP, a TAG associated with a TRP that first establishes an initial connection with a UE in a serving cell serving the UE as a TAG corresponding to a first TAG identifier in the first indication information.

6. The method according to claim 1, wherein a TAC MAC-CE comprises second indication information of a TAG, and the second indication information occupies four bits of the TAC MAC-CE; and wherein the predetermined threshold is 16.

7. The method according to claim 6, wherein the TAC MAC-CE comprising the second indication information of the TAG comprises:
setting first two bits of an Oct2 and last two bits of an Oct1 in the TAC MAC-CE as the second indication information of the TAG.

8. The method according to claim 6, wherein configuring the at least one independent TAG for the TRP comprises:
defining, for an inter-cell M-TRP, a TAG associated with a TRP in a serving cell serving a UE as a TAG corresponding to a first TAG identifier in the second indication information.

9. The method according to claim 6, wherein configuring the at least one independent TAG for the TRP comprises:
defining, for an intra-cell M-TRP, a TAG associated with a TRP that first establishes an initial connection with a UE in a serving cell serving the UE as a TAG corresponding to a first TAG identifier in the second indication

10. The method according to claim 1, wherein configuring the at least one independent TAG for the TRP comprises:
configuring, for two TRPs serving a UE, a first TAT for a first TRP and a second TAT for a second TRP in the two TRPs, wherein the first TRP is a TRP that first completes an initial connection with the UE.

11. The method according to claim 10, wherein the method further comprises:
performing, on uplink time-domain resources corresponding to the second TRP, transmissions of a physical uplink shared channel (PUSCH), a physical uplink control channel (PUCCH) and a sounding reference signal (SRS) corresponding to the UE via the second TRP, in a case where the first TAT expires and the second TAT does not expire.

12. The method according to claim 11, wherein after the first TAT expires, wherein the method further comprises:
acquiring, by the first TRP, a new TA to restart the first TAT, in a case where the first TRP initiates a random access request.

13. The method according to claim 11, wherein the first TRP initiating the random access request comprises:
triggering, via a physical downlink control channel (PDCCH) command, the random access request initiated by the first TRP.

14. The method according to claim 10, wherein the method further comprises:
performing, on uplinkead time-domain resources corresponding to the first TRP, transmissions of a PUSCH, a PUCCH and an SRS corresponding to the UE via the first TRP by using a TA value of the second TRP, in a case where the first TAT expires and the second TAT does not expire.

15. The method according to claim 14, wherein after the first TAT expires, wherein the method further comprises:
acquiring, by the first TRP and the second TRP, a new TA to restart the first TAT and the second TAT respectively, in a case where the UE re-initiates a random access request with the first TRP and the second TRP.

16. (canceled)

17. A communication device, comprising one or morea processors and a memory storing a computer program, wherein the one or more processors are communicatively coupled to the memory, wherein the computer program when collectively executed by the one or more processors causes the communication device to:
configure at least one independent TAG for a transmission reception point (TRP), wherein a total number of the at least one independent TAG that is configurable does not exceed a predetermined threshold; and
configure one TAT for one TAG.

18. A non-transitory computer-readable storage medium storing instructions, wherein the instructions, when executed, implement the following steps:
configuring at least one independent TAG for a transmission reception point (TRP), wherein a total number of the at least one independent TAG that is configurable does not exceed a predetermined threshold; and
configuring one TAT for one TAG.

19. The communication device according to claim 17, wherein a time advance command (TAC) medium access control-control element (MAC-CE) comprises first indication information of a TAG, and the first indication information occupies three bits of the TAC MAC-CE; and wherein the predetermined threshold is 8.

20. The communication device according to claim 19, wherein the computer program when collectively executed by the one or more processors causes the communication device to:
set first two bits of an octet Oct2 and a last bit of an octet 1Oct1 in the TAC MAC-CE as the first indication information of the TAG.

21. The communication device according to claim 17, wherein a TAC MAC-CE comprises second indication information of a TAG, and the second indication information occupies four bits of the TAC MAC-CE; and wherein the predetermined threshold is 16.
